(19) United States
(12) Patent Application Publication
(10) Pub. No.: US 2006/0191595 A1
(43) Pub. Date: Aug. 31, 2006

(54) HOVERING ROUTER BASE

(76) Inventor: Thomas E. Stoffel, Andover, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/906,641

(22) Filed: Feb. 28, 2005

(51) Int. Cl. B27C 5/10; B27C 1/00; B23C 1/20

(52) U.S. Cl. 144/136.95; 144/154.5; 409/182

(57) ABSTRACT

A base (10) for a router includes a sub base (12) having a plurality of dispersed air ducts (24) extending through the lower surface (14) and spaced from a central opening (20) and its periphery (18). First and second plates (30, 50) form a manifold (28) providing pressurized air to the air ducts (24) to create a cushion of air between the lower surface (14) and the work piece during operation of the router. The air ducts (24) are arranged in a plurality of circumferentially spaced, radial lines each including multiple air ducts (24) and in fluid communication with a radial channel (44) formed in the first plate (30) in turn in fluid communication with a groove (64) formed in the second plate (50).

### BACKGROUND

The present invention generally relates to bases for hand tools which hover over the work piece, particularly to bases for hand tools which hover over the work piece utilizing pressurized air, and in the most preferred form to hovering router bases.

Utilizing a conventional router, the base of the router rests on the work piece with a cutting tool extending into the work piece. The base can be donut-shaped with the cutting tool extending through the center opening, or the cutting tool can extend outside the periphery of the base allowing routing of internal corners. Considerable effort is required to move the router over the work piece, especially for extended lengths of time, due to the friction between the base of the router and the work piece. In particular, routers can often weight as much as 15 pounds. Also, debris from the cutting operation often becomes captured between the base of the router and the work piece.

Thus, a need exists in the industry for a manner of manually moving hand tools relative to a work piece which reduces friction therebetween and otherwise reduces the effort of the craftsperson for moving the hand tool relative to the work piece.

### SUMMARY

The present invention solves this need and other problems in the field of hand tools, in the preferred form, by hovering the hand tool spaced from and generally parallel to the work piece by creating a cushion of air between the lower surface of the hand tool and the work piece. In most preferred aspects, the cushion of air is created by flowing air through a plurality of dispersed air ducts included in the lower surface and located inwardly of the periphery of the lower surface.

In further aspects of the present invention, the plurality of air ducts are arranged in a plurality of linearly straight lines and extend from the lower surface to a plurality of linearly straight channels spaced from the lower surface. In most preferred forms, the plurality of linearly straight lines and the plurality of linearly straight channels are radially arranged and circumferentially spaced.

In still further preferred aspects of the present invention, the hand tool is in the form of a router having a tool bit rotatable about an axis extending through a central opening formed in the lower surface and spaced from the periphery.

In other aspects of the present invention, the lower surface is formed of friction reducing material which is wear-resistant and in the most preferred form is located on a sub base formed as a separate component from the hand tool and/or from other components of the base and removably secured thereto to allow replacement, interchange and formation of materials different than the other components of the hand tool and/or of the base.

In further aspects of the present invention, the base including the sub base further includes a manifold mounted to the hand tool and providing pressurized air to the air ducts. The manifold of the preferred form includes first and second plates and an air distribution system which is believed to produce synergistic results in ease of fabrication and assembly, costs, as well as overall operation and function.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a hovering base for a hand tool in the most preferred form of a router shown in phantom according to the preferred teachings of the present invention.

FIGS. 2-4 show plan views of separate components of the hovering base of FIG. 1.

FIG. 5 shows a partial cross sectional view of the hovering base of FIG. 1 in operation.

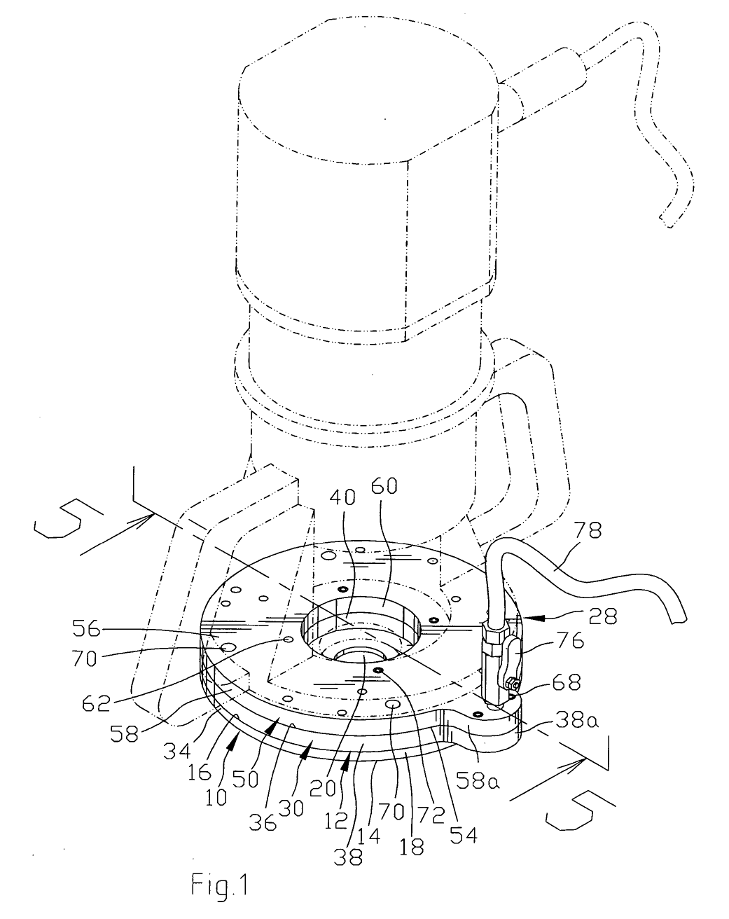

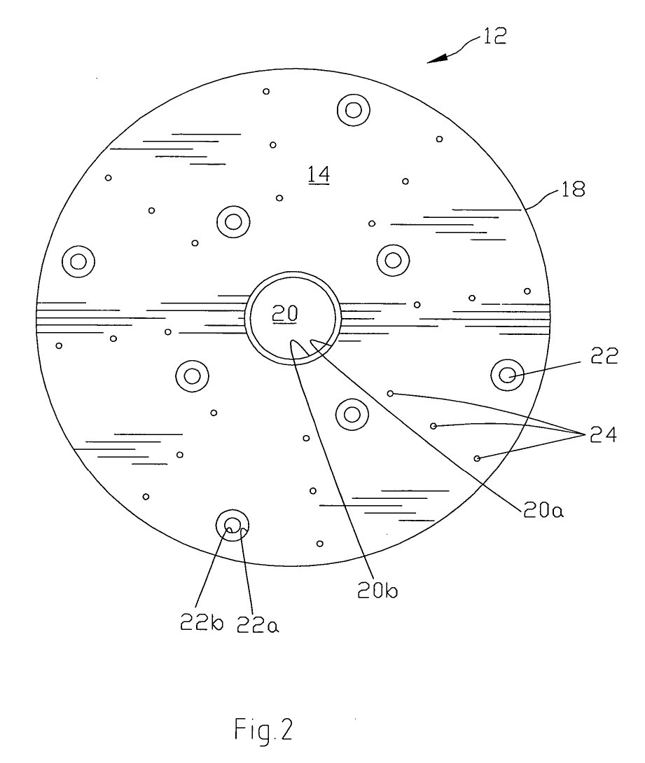

All figures are drawn for ease of explanation of the basic teachings of the present invention only; the extensions of the figures with respect to number, position, relationship, and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in the various figures of the drawings, the same numerals designate the same or similar parts. Furthermore, when the terms “first”, “second”, “upper”, “lower”, “axial”, “radial”, and similar terms are used herein, it should be understood that these terms have reference only to the structure shown in the drawings as it would appear to a person viewing the drawings and are utilized only to facilitate describing the illustrative embodiment.

### DESCRIPTION

A hovering base for a hand tool according to the preferred teachings of the present invention is shown the drawings and generally designated 10. The hand tool performs an operation such as cutting on a work piece when the hand tool is manually moved along and relative to the work piece. In the most preferred form, the hand tool is in the form of a router having a tool bit 80 rotatable about an axis. The work piece should present a solid, flat surface and includes but is not limited to laminates and wood. In the preferred form, base 10 includes a sub base 12 including a lower surface 14, an upper surface 16 opposite to the lower surface 14, and an outer periphery 18. Lower surface 14 is adapted to travel along the work piece. In the form shown, outer periphery 18 is generally circular in shape but could be of other shapes including but not limited to generally square. In the form shown, sub base 12 includes a center opening 20 spaced from periphery 18 and adapted to receive rotating cutting tool bit 80 of the hand tool. In the preferred form, central opening 20 is circular in shape with the rotating axis of cutting bit 80 extending through center opening 20 along the axis of the circular shape. Center opening 20 includes a first generally cylindrical portion 20a extending from lower surface 14 towards but spaced from upper surface 16 and a second generally cylindrical portion 20b extending from portion 20a to upper surface 16. Portion 20b has a smaller diameter than portion 20a to create a shoulder in opening 20. Sub base 12 includes a plurality of securement bores 22 extending between surfaces 14 and 16 and spaced from periphery 18 and opening 20. In the most preferred form, bores 22 include a first, counter bore 22a shown in the preferred form as frustoconical in shape extending from lower surface 14 towards but spaced from upper surface 16 and a second, cylindrical bore 22b extending from counter bore 22a to upper surface 16.

According to the preferred teachings of the present invention, sub base 12 further includes a plurality of dispersed air ducts 24 extending between surfaces 14 and 16 and spaced from periphery 18 and opening 20 and terminating in lower surface 14. Air ducts 24 are distributed throughout the area of lower surface 14 and in the preferred form shown are arranged in a plurality of linearly straight lines and in the most preferred form which are arranged radially spaced along the linear lines which are circumferentially spaced from each other. In the preferred form, three air ducts 24 are provided in each of eight radial lines.

Sub base 12 is formed of any suitable material which is durable and maintains lower surface 14 in a flat condition over extended use, which minimizes friction with the work piece, and which generally resists wear from engagement with the work piece and debris. In the most preferred form, sub base 12 is formed of phenolic material as a single, unitary component.

According to the teachings of the present invention, base 10 further includes a mounting manifold 28 adapted to be mounted to the hand tool. Manifold 28 provides pressurized air to air ducts 24 and mounts the sub base 12 to the hand tool such as a router as shown. In the preferred form, manifold 28 is formed by first and second plates 30 and 50. Plates 30 and 50 are formed of any suitable material which is generally air impervious, which is easy to machine, and which maintains its shape over time. In the most preferred form, plates 30 and 50 are formed of metal such as aluminum. Thus, sub base 12 which is formed as a separate component from manifold 28 to allow replacement and interchange can be formed of different material than manifold 28 and/or the hand tool. Likewise, forming plates 30 and 50 out of metal allows their machining to be true and flat. Additionally, although shown in the preferred form formed from two stacked plates 30 and 50, manifold 28 can be formed of other configurations and/or form a single, unitary component or from a greater number of components than shown according to the teachings of the present invention.

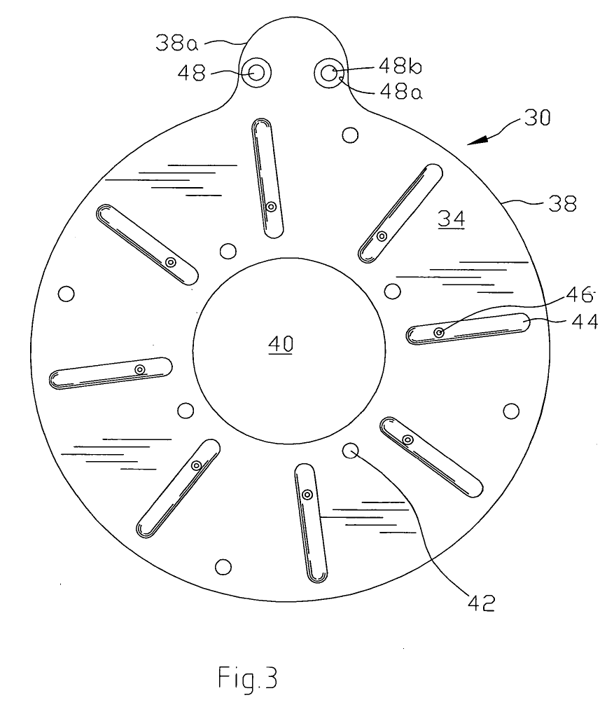

A preferred form of plate 30 is shown in FIG. 3 and generally includes a lower surface 34, an upper surface 36 and an outer periphery 38. Outer periphery 38 has a shape and size generally corresponding to periphery 18. In the form shown, outer periphery 38 includes an extension tab 38a extending outwardly of periphery 18 and having a circumferential width substantially smaller than peripheries 18 and 38. In the form shown, plate 30 includes a center opening 40 extending between surfaces 34 and 36 and of a size larger than center opening 20. Plate 30 includes a plurality of securement bores 42 extending between surfaces 34 and 36 at locations corresponding to bores 22 and of a size corresponding to cylindrical bores 22b.

According to the preferred teachings of the present invention, plate 30 includes a plurality of linearly straight channels 44 extending from lower surface 34 towards but spaced from upper surface 36 and in the most preferred form are arranged radially and are circumferentially spaced. Channels 42 are provided at locations corresponding to each of the radial lines of air ducts 24. An air port 46 extends from each channel 42 to upper surface 36, with air ports 46 located at equal or the same radial extent. Plate 30 further includes bores 48 located in extension tab 38a. In the most preferred form, bore 48 include a first counter bore 48a shown in the preferred form as frustoconical in shape extending from lower surface 34 towards but spaced from upper surface 36 and a second, cylindrical bore 48b extending from counter bore 48a to upper surface 36.

Plate 30 is stacked upon sub base 12 with lower surface 34 flushly abutting with upper surface 16 and with peripheries 18 and 38 and bores 42 and 22b aligned. Thus, channels 44 are spaced from lower surface 14, and air ducts 24 extend from lower surface 14 to channels 44.

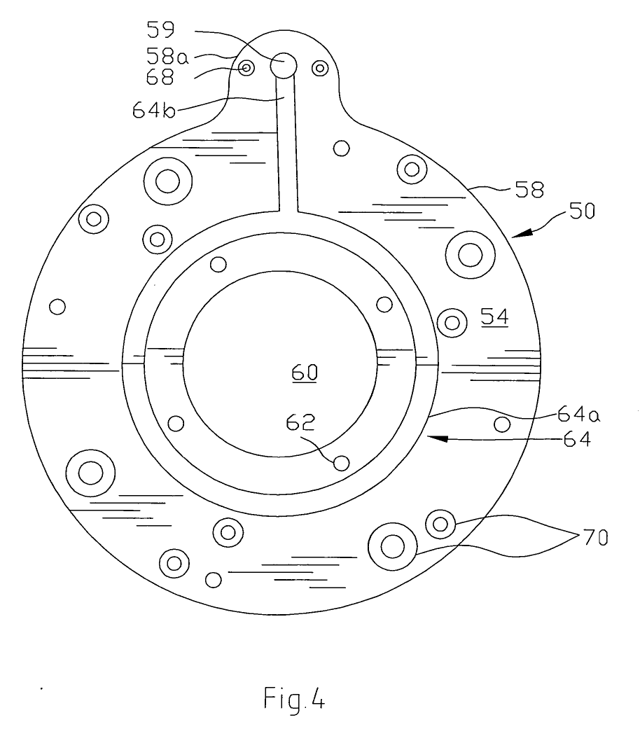

A preferred form of plate 50 is shown in FIG. 4 and generally includes a lower surface 54, an upper surface 56, and an outer periphery 58. Outer periphery 58 has a shape and size generally corresponding to peripheries 18 and 38. In the form shown, outer periphery 58 includes an extension tab 58a of a shape, size and location corresponding to extension tab 38a. In the form shown, plate 50 includes a center opening 60 extending between surfaces 54 and 56 and of a size corresponding to opening 40. Plate 50 includes a plurality of threaded securement bores 22 and 42 and of a size corresponding to bores 22b and 42.

According to the preferred teachings of the present invention, plate 50 includes an air distribution groove 64 extending from lower surface 54 toward but spaced from upper surface 56. Groove 64 is provided at a location corresponding to and in fluid communication with each air port 46. In the preferred form shown, groove 64 includes a generally annular portion 64a of a circular shape having a radius corresponding to the radial extent of air ports 46. Groove 64 further includes a radial portion 64b of a linear shape extending from portion 64a into extension tab 58a. An air inlet 59 in fluid communication with groove 64 is located in extension tab 58a and extends from portion 64b to upper surface 56, with inlet 59 intersecting portion 64b in the form shown. In the preferred form, inlet 59 is threaded for threadable receipt of a coupler 76 of an air line 78. In the most preferred form, the coupler 76 includes an on/off valve for regulating air flow into inlet 59.

Plate 50 further includes threaded bores 68 located in extension tab 58a at locations corresponding to bores 48, of a size corresponding to bores 48b and extending between surfaces 54 and 56.

Plate 50 of manifold 28 further includes suitable provisions 70 for securing manifold 28 and base 10 to the hand tool such as a router. It should be appreciated that provisions 70 must be adapted to correspond to the securement type and location of the particular hand tool and in the most preferred form of the particular hand tools of different manufacturers and, preferably, without modification to the hand tool. Thus, provisions 70 can take several forms and would be within the skill of the art. In the preferred form shown, provisions 70 are shown as frustoconical bores extending between surfaces 54 and 56 of differing sizes and at different mounting patterns.

Plate 50 is stacked upon plate 30 with lower surface 54 flushly abutting with upper surface 36 and with peripheries 18, 38 and 58, extension tabs 38a and 58a, bores 22b, 42 and 62, and bores 48b and 68 aligned. Sub base 12 and plates 30 and 50 are suitably secured together such as by screws 72 extending through bores 22, 42 and 48 and threaded into bores 62 and 68, respectively.

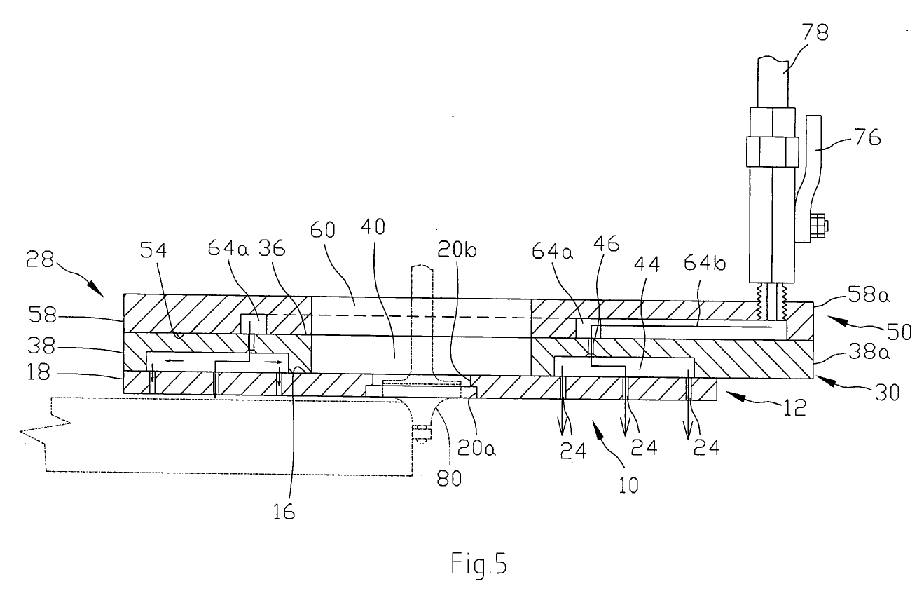

In operation, base 10 is secured to the hand tool and air line 78 is connected to a suitable source of compressed air such as shop air. In the preferred form shown, the axis of rotating cutting bit 80 of a router extends through center openings 20, 40 and 60 to engage the work piece. When it is desired to operate the hand tool, the valve of coupler 76 is opened. Thus, air is directed under lower surface 14 and sub base 12 by flowing through inlet 59 and into and through portions 64b and 64a, ports 46, channels 44 and air ducts 24. When placed adjacent to the work piece, the air directed against the work piece by air ducts 24 flows between lower surface 14 and the work piece to create a cushion of air therebetween during the operation of the hand tool on the work piece as diagrammatically shown in FIG. 5. Therefore, base 10 and the hand tool mounted thereon is able to hover over the work piece, with the spacing between base 10 and the work piece being exaggerated in FIG. 5 for ease of illustration. Thus, harsh contact and friction between base 10 and the work piece is practically eliminated, making movement of the hand tool relative to the work piece easier and with less effort. The air flow between lower surface 14 and the work piece also helps to prevent debris from the routing operation from lodging between surface 14 and the work piece which could scratch the work piece. Operation can be controlled with the resistance of the cutting bit with the work piece rather than the friction between surface 14 and the work piece such that a new level of feel and improved quality and precision of cut can be obtained.

Now that the basic teachings of the present invention have been explained, many extensions and variations will be obvious to one having ordinary skill in the art. For example, although the particular manner of creating the cushion of air between the base 10 and the work piece is believed to be advantageous for several reasons including ease of fabrication and assembly, other manners for creating the cushion of air can be utilized according to the teachings of the present invention. In particular, air flow must be provided through ducts 24 to create a cushion of air even though many of such ducts 24 are not located adjacent to the work piece such as in the case of a router routering an edge of a work piece and while providing sufficient stability for the hand tool during operation. In particular, although utilizing numerous ducts 24 of a size restricting air flow in the preferred form, other manners of restricting air flow can be provided according to the teachings of the present invention.

It should be appreciated that although the configuration and arrangement of air ducts 24, channels 44 and groove 64 shown produce synergistic results, air ducts 24, channels 44 and groove 64 can have other configurations and arrangements according to the preferred teachings of the present invention especially when cutting bit 80 does not extend through central openings 20, 40 and 60. As an example, rather than radially arranged and circumferentially spaced, the linearly straight lines of air ducts 24 could have other arrangements including in a parallel, spaced arrangement according to the teachings of the present invention. Likewise, although shown formed in separate plates 30 and 50, channels 44 and groove 64 could be formed in the same component which could integrally include or be separate from the sub base 12.

Furthermore, although shown located in extension tab 58 of the preferred form, extension tabs 38 and 58 could be eliminated and inlet 59 located at another position including the peripheries 38 and/or 58 of plates 30 and 50 according to the teachings of the present invention.

Likewise, although shown and described as being a separate component as an added option intended to be secured to an existing hand tool, base 10 according to the teachings of the present invention could be incorporated into and marketed with the hand tool as a single unit if desired.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. Base for a hand tool performing an operation on a work piece comprising, in combination: a sub base having a lower surface adapted to travel along the work piece, with the lower surface including a plurality of dispersed air ducts terminating in the lower surface; and a manifold adapted to be mounted to the hand tool, with the manifold providing pressurized air into the air ducts to create a cushion of air between the lower surface and the work piece during the operation of the hand tool on the work piece.

2. The base of claim 1 with the sub base including a center opening and a periphery, with the center opening being spaced from the periphery and adapted to receive a cutting bit of the hand tool.

3. The base of claim 2 with the sub base being formed as a separate component from the manifold, with the sub base being removably secured to the manifold allowing replacement and interchange.

4. The base of claim 3 with the sub base formed from phenolic material and with the manifold formed of metal.

5. The base of claim 3 with the periphery of the sub base being circular.

6. The base of claim 3 with the plurality of air ducts arranged in a plurality of circumferentially spaced, radial lines, with each radial line including multiple air ducts.

7. The base of claim 6 with the manifold including a plurality of circumferentially spaced, radial channels, with one of the radial channels provided corresponding to each of the radial lines.

8. The base of claim 7 with the sub base having an upper surface opposite to the lower surface, and with the air ducts extending between the upper and lower surfaces of the sub base; with the manifold including a first plate having a lower surface and an upper surface, with the lower surface of the first plate flushly abutting the upper surface of the sub base, with the radial channels formed in the first plate and extending from the lower surface towards but spaced from the upper surface of the first plate, with the first plate further including an air port extending from each of the channels to the upper surface of the first plate, with the manifold further including a second plate secured to the first plate, with the second plate including an air groove in fluid communication with each of the air ports.

9. The base of claim 8 with the first and second plates each having a periphery of a shape and size corresponding to the periphery of the sub base, with the first and second plates each including an extension tab extending outwardly of the periphery of the sub base, with the air groove extending into the extensions tabs of the first and second plates, with an inlet formed in the extension tab of the second plate and in fluid communication with the air groove.

10. The base of claim 9 with the air ports having an equal radial extent, with the second plate having a lower surface flushly abutting the upper surface of the first plate, with the air groove extending in the second plate from the lower surface and including an annular portion corresponding to the radial extent of the air ports, with the air groove further including a linear portion extending from the annular portion to the inlet.

11. The base of claim 10 with the second plate being formed as a separate component from the hand tool, with the second plate being removably secured to the hand tool allowing addition thereto.

12. The base of claim 8 with the first and second plates each having a periphery of a shape and size corresponding to the periphery of the sub base, with an inlet formed in the second plate and in fluid communication with the air groove, with the air ports having an equal radial extent, with the second plate having a lower surface flushly abutting the upper surface of the first plate, with the air groove extending in the second plate from the lower surface and including an annular portion corresponding to the radial extent of the air ports, with the second plate being formed as a separate component from the hand tool, with the second plate being removably secured to the hand tool allowing addition thereto.

13. The base of claim 1 with the plurality of air ducts arranged in a plurality of linearly straight lines, with each of the linearly straight lines including multiple air ducts, with the manifold including a plurality of linearly straight channels, with one of the linearly straight channels provided corresponding to each of the linearly straight lines, with each of the linearly straight channels being spaced from the lower surface, with the air ducts each extending from the lower surface to one of the plurality of linearly straight channels.

14. The base of claim 13 with the sub base having a periphery, with the air ducts being dispersed in the lower surface spaced from the periphery.

15. The base of claim 14 with the sub base formed from phenolic material.

16. The base of claim 15 with the sub base being formed as a separate component from the manifold, with the sub base being removably secured to the manifold allowing replacement and interchange, with the plurality of linearly straight lines and the plurality of linearly straight channels being radially arranged and circumferentially spaced.

17. Method for operating on a work piece comprising: providing a hand tool having a lower surface traveling along the work piece; creating a cushion of pressurized air between the lower surface and the work piece to slightly space the lower surface from and generally parallel to the work piece; and moving the hand tool relative to the work piece on the cushion of pressurized air to perform an operation on the work piece.

18. The method of claim 17 with creating the cushion of pressurized air comprising flowing air through a plurality of dispersed air ducts included in the lower surface and located inwardly of a periphery of the lower surface.

19. The method of claim 18 with providing the hand tool comprising rotating a tool bit extending through a central opening formed in the lower surface and spaced from the outer periphery, with flowing air comprising flowing air through the plurality of dispersed air ducts spaced from the central opening.

20. The method of claim 19 with rotating the tool bit comprising rotating the tool bit about an axis extending through the central opening.
